(19) United States
(12) Patent Application Publication
(10) Pub. No.: US 2023/0271544 A1
(43) Pub. Date: Aug. 31, 2023

(54) MONOCOQUE RECREATIONAL TRAILER

(71) Applicant: Infusion Design, Inc., Bonner Springs, KS (US)

(72) Inventors: Sean Elsner, Bonner Springs, KS (US); Tim Baine, Bonner Springs, KS (US)

(73) Assignee: Infusion Design, Inc., Bonner Springs, KS (US)

(21) Appl. No.: 18/115,548

(22) Filed: Feb. 28, 2023

Related U.S. Application Data
(60) Provisional application No. 63/314,933, filed on Feb. 28, 2022.

(51) Int. Cl. B60P 3/34; B60P 3/38

(52) U.S. Cl. CPC B60P 3/34; B60P 3/38

(57) ABSTRACT

A recreational trailer with a monocoque body mounted on a chassis. Modularly interlocking and adjustable construction segments are mechanically fastened forming a monocoque body. Each component of the present invention may be individually altered to adjust the dimensions and/or functionality of the recreational trailer. The recreational trailer may be altered by resizing various panels to create different embodiments of the recreational trailer that are longer and/or taller and shorter and/or smaller. The various panels may be integrated and locked together to form an integral structure.

### CROSS REFERENCE TO RELATED APPLICATION

This application claims benefit of co-pending provisional application Ser. No. 63/314,933, filed Mar. 28, 2022, entitled MONOCOQUE RECREATIONAL TRAILER.

### FIELD

The present invention generally relates to a recreational trailer, and more particularly, to a monocoque recreational trailer, which is scalable to meet the needs of a user.

### BACKGROUND

Recreational trailers, such as camping trailers and travel trailers, are known in the art. The recreational trailer is towed behind a vehicle and provides a place to sleep, which is more secured, protected and comfortable than a tent. Recreational trailers allow for traveling without the expense of a hotel, and enables staying in locations where other accommodations are not available. Recreational trailers vary from basic models, which may be little more than a tent on wheels, to those with one or more rooms, furniture, storage areas and other fixtures.

Typically, recreational trailers are designed and constructed to be mounted on a base chassis frame. The body of the recreational trailer includes a structural frame to which exterior panels are fixed to form a shell. Interior frame members are included to provide support and structural integrity to the shell, and to support interior cabinets, storage areas, a bed, and other fixtures. The structural framework of prior art recreational trailers adds weight to the trailer. To compensate for the added weight of the framework, the weight of other components such as exterior and interior panels, interior shelves and cabinets, interior fixtures and the chassis must be reduced to accommodate for towing limits of the vehicle. This weight reduction often requires a compromise in the quality, durability and strength of the materials used for the recreational trailer.

### SUMMARY

Embodiments of the invention are defined by the claims below, not this summary. A high-level overview of various aspects of the invention is provided here to introduce a selection of concepts that are further described in the Detailed Description section below. This summary is not intended to identify key features or essential features of the claimed subject matter, nor is it intended to be used in isolation to determine the scope of the claimed subject matter.

The present invention is directed to a recreational trailer with a monocoque body mounted on a chassis. Modularly interlocking and adjustable construction segments are mechanically fastened forming a monocoque body. Each component of the present invention may be individually altered to adjust the dimensions and/or functionality of the recreational trailer. The recreational trailer of the present invention may be altered by resizing various panels to create different embodiments of the recreational trailer that are longer and/or taller and shorter and/or smaller. The various panels may be integrated and locked together to form an integral structure. By eliminating a separate structural framework, the part count is reduced, thus reducing the weight and cost, which may be utilized to incorporate higher quality panels and parts. The shape and design of components may be designed to obscure and protect the aspects of a trailer that typically leak by positioning joints within segments of paneling thereby increasing structural integrity.

Other advantages of the present invention will become apparent from the following description taken in connection with the accompanying drawings, wherein is set forth by way of illustration and example an embodiment of the present invention.

### BRIEF DESCRIPTION OF THE DRAWINGS

FIG. 1 is a right side view of an embodiment of the recreational trailer of the present invention.

FIG. 2 is a top view of the embodiment of the recreational trailer of FIG. 1.

FIG. 3 is a left side view of the embodiment of the recreational trailer of FIG. 1.

FIG. 4 is a front view of the embodiment of the recreational trailer of FIG. 1.

FIG. 5 is a rear view of the embodiment of the recreational trailer of FIG. 1.

FIG. 6 is a sectional view of the embodiment of the recreational trailer of FIG. 2 along line 6-6.

FIG. 7 is a sectional view of the embodiment of the recreational trailer of FIG. 2 along line 7-7.

FIG. 8 is a sectional view of the embodiment of the recreational trailer of FIG. 3 along line 8-8.

FIGS. 9-36 are assembly views of the embodiment of the recreational trailer of FIG. 1.

FIG. 37 is a cross-sectional view of a panel of the embodiment of the recreational trailer of FIG. 1.

FIG. 38 is a side illustration of an expanded embodiment of a recreational trailer of the present invention.

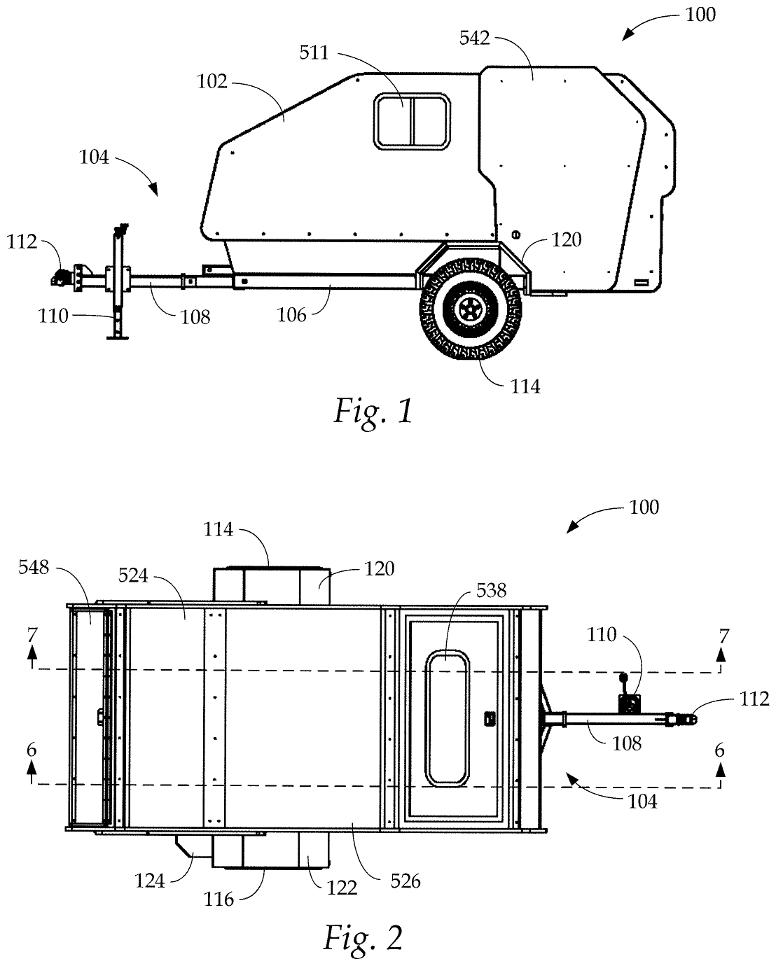

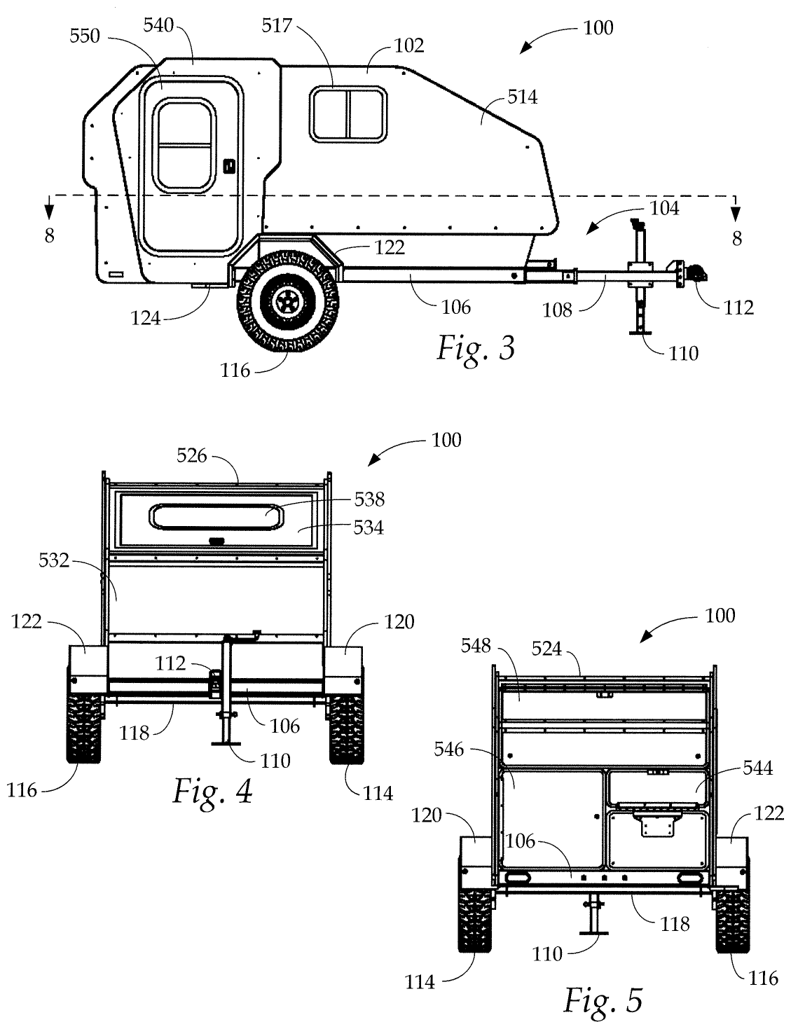

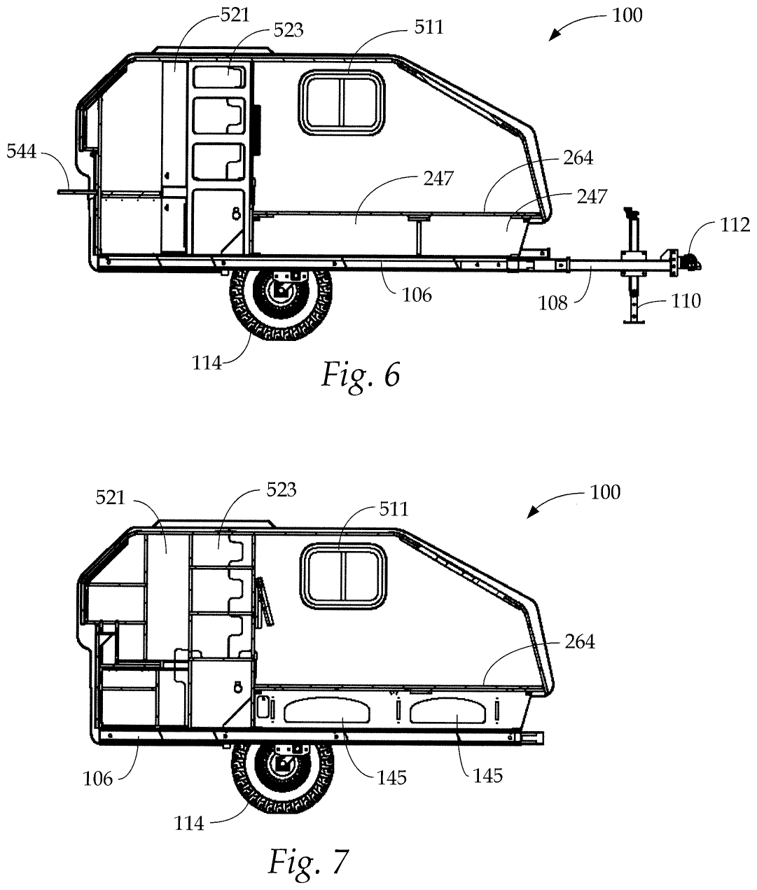

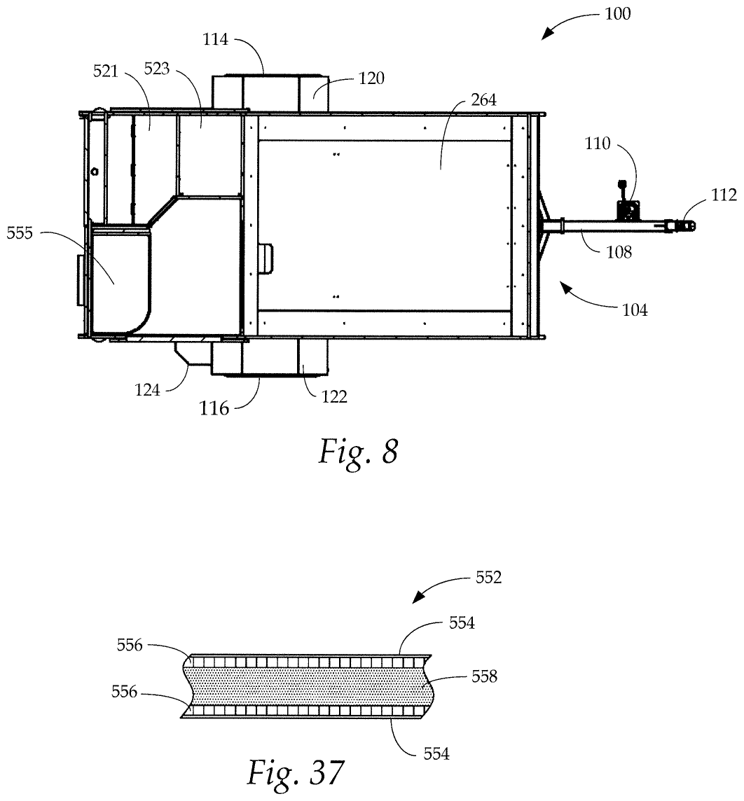

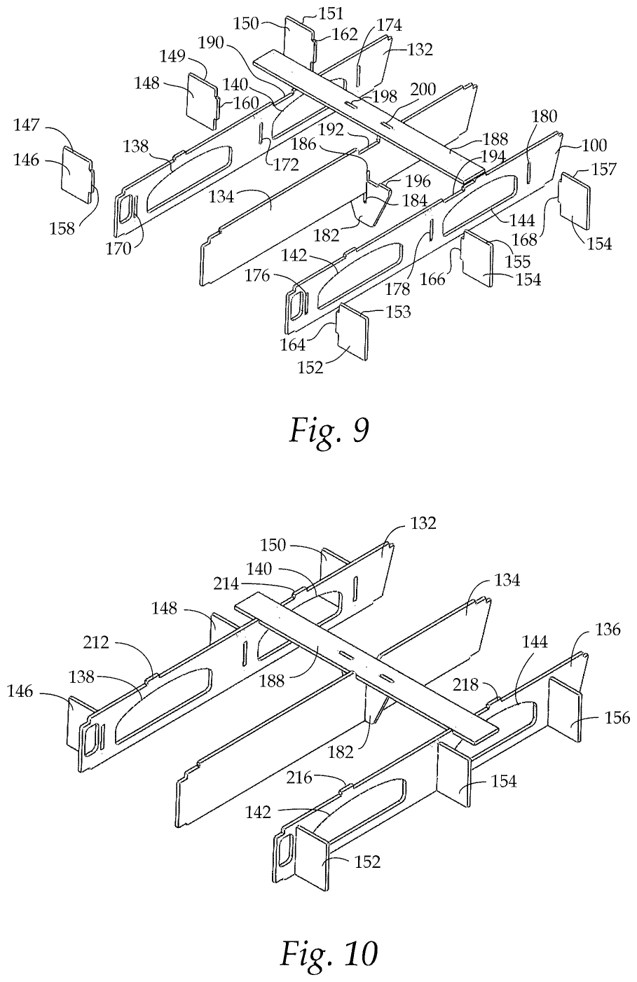

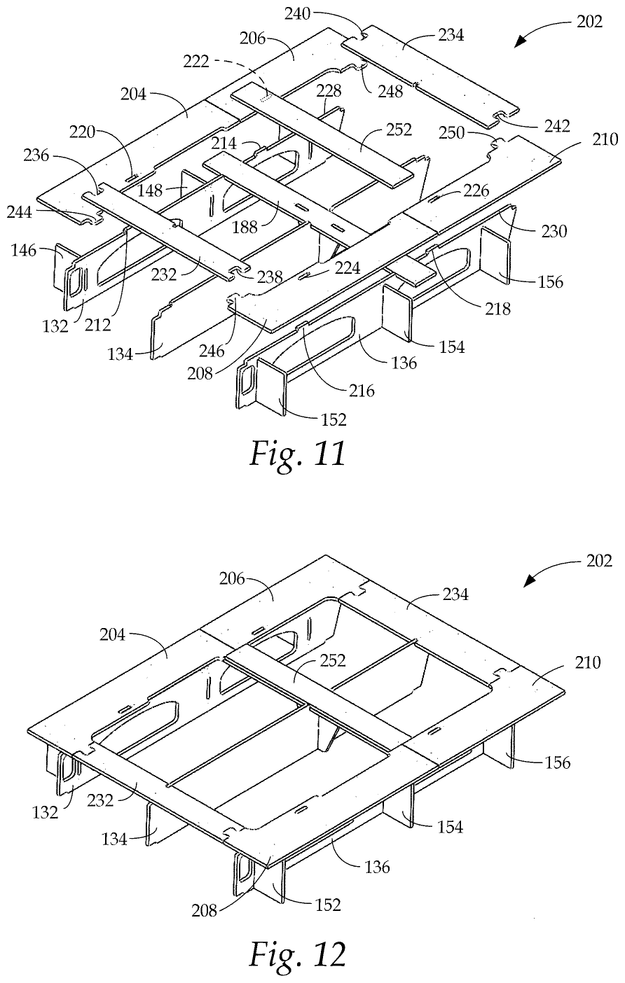

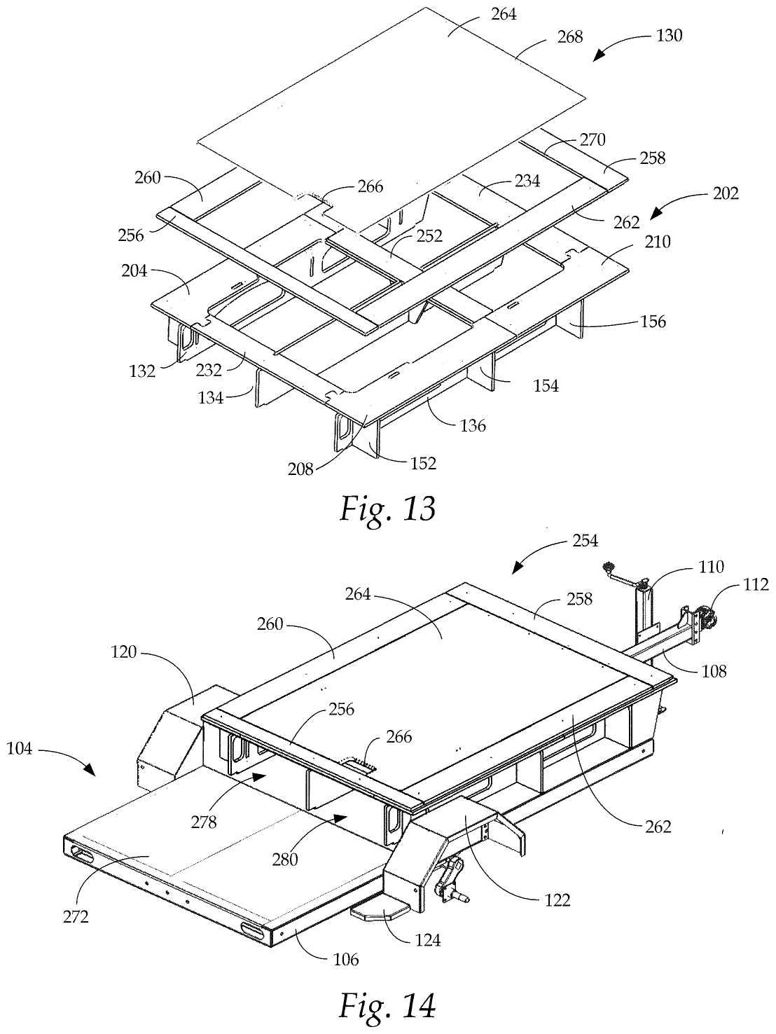

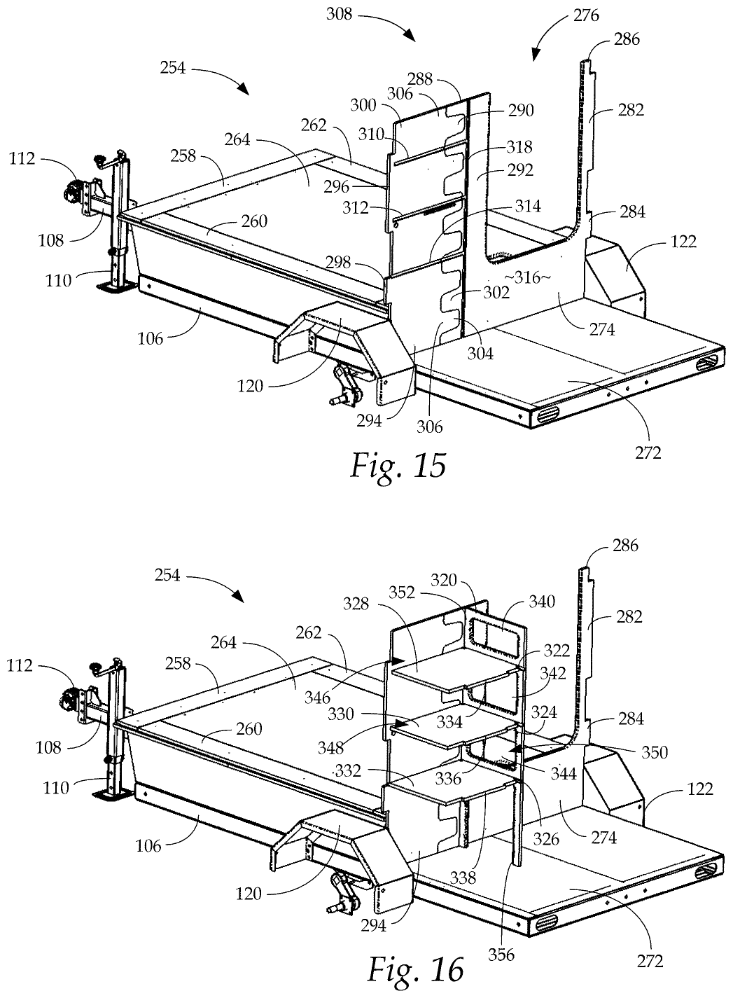

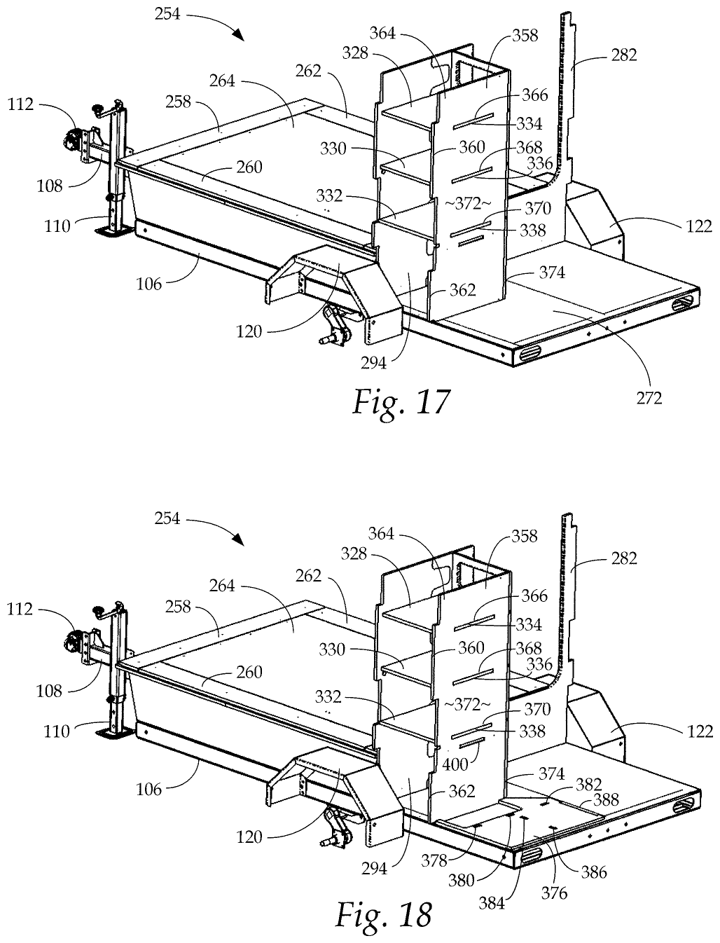

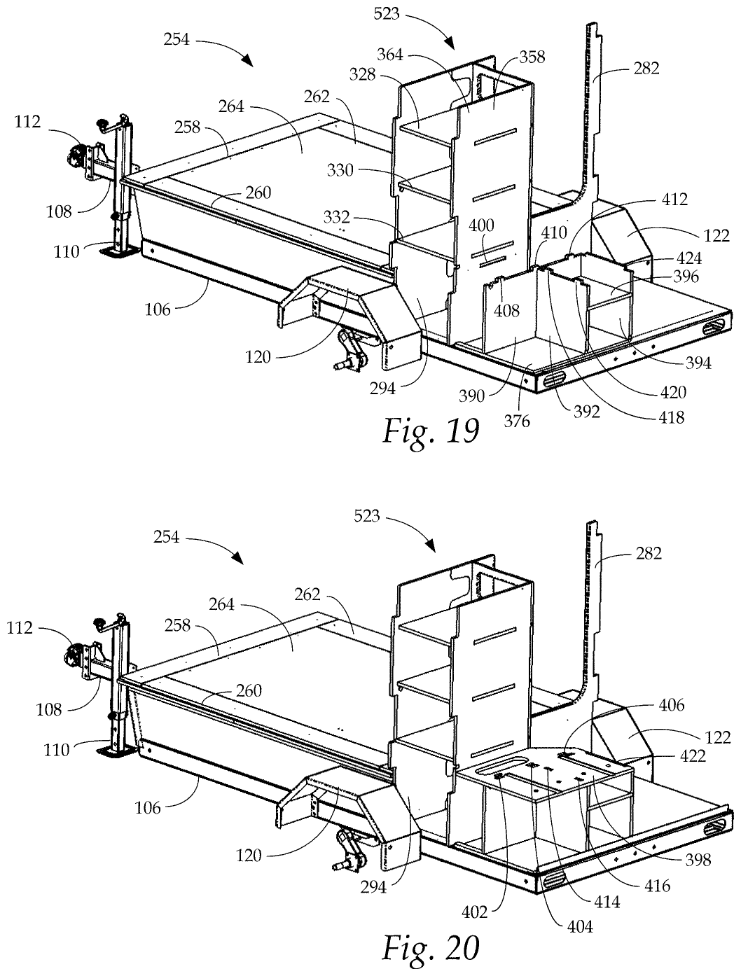

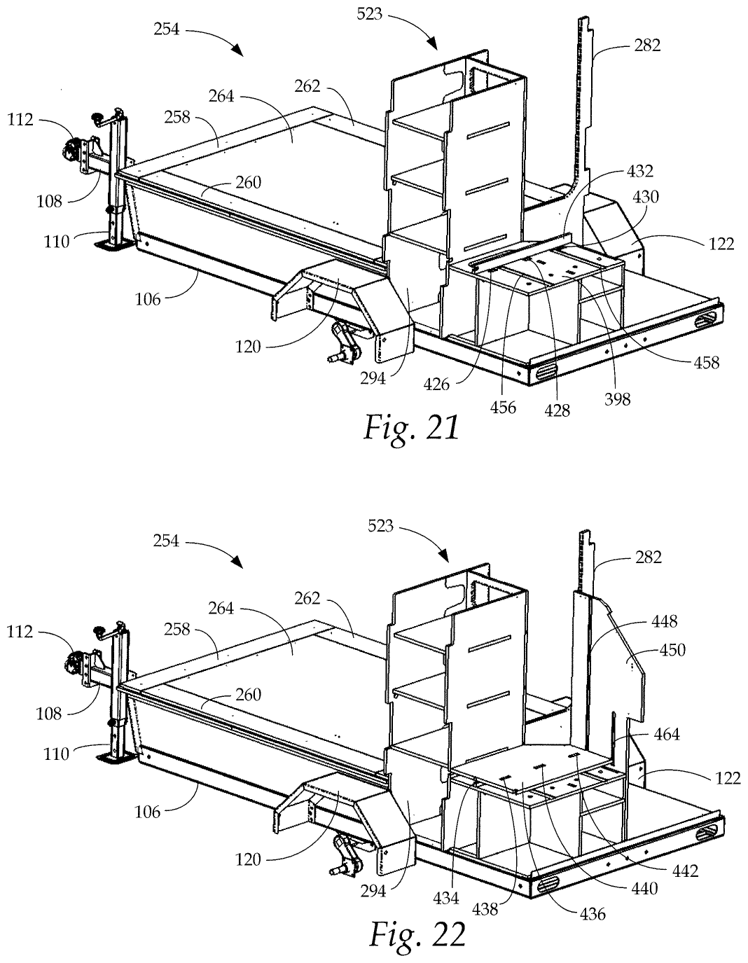

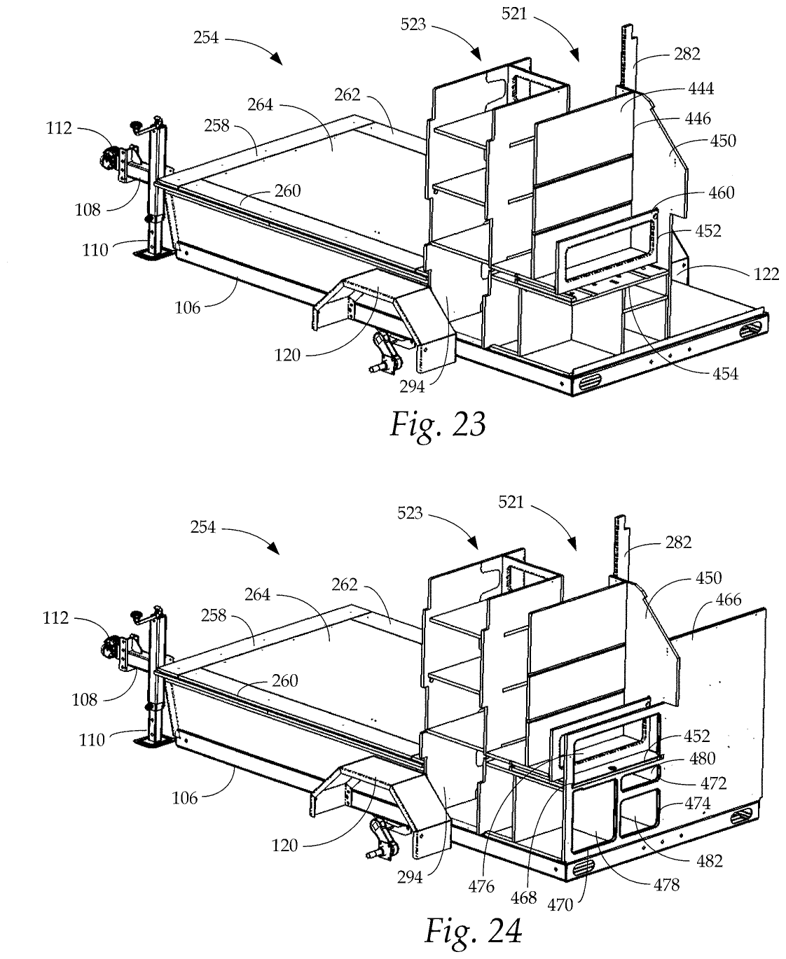

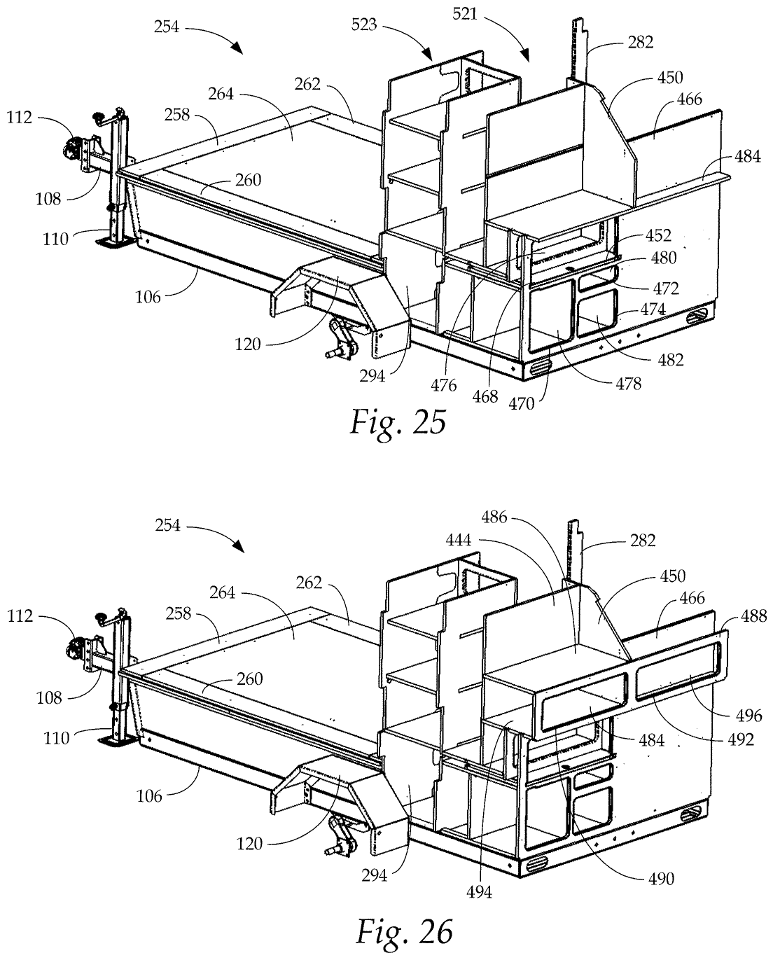

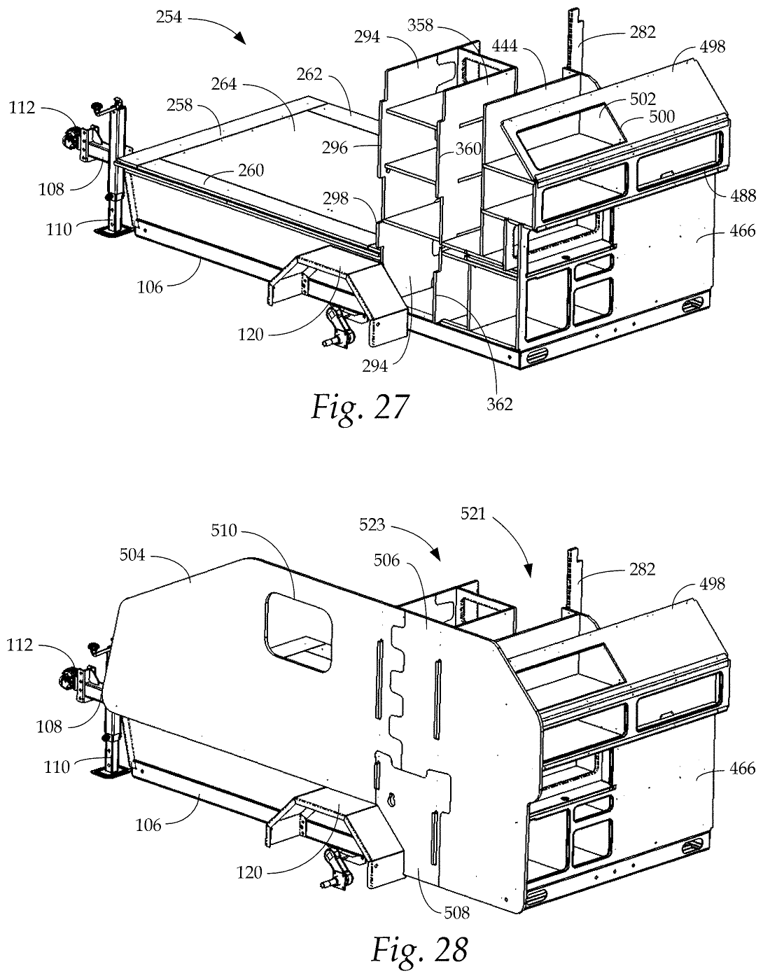

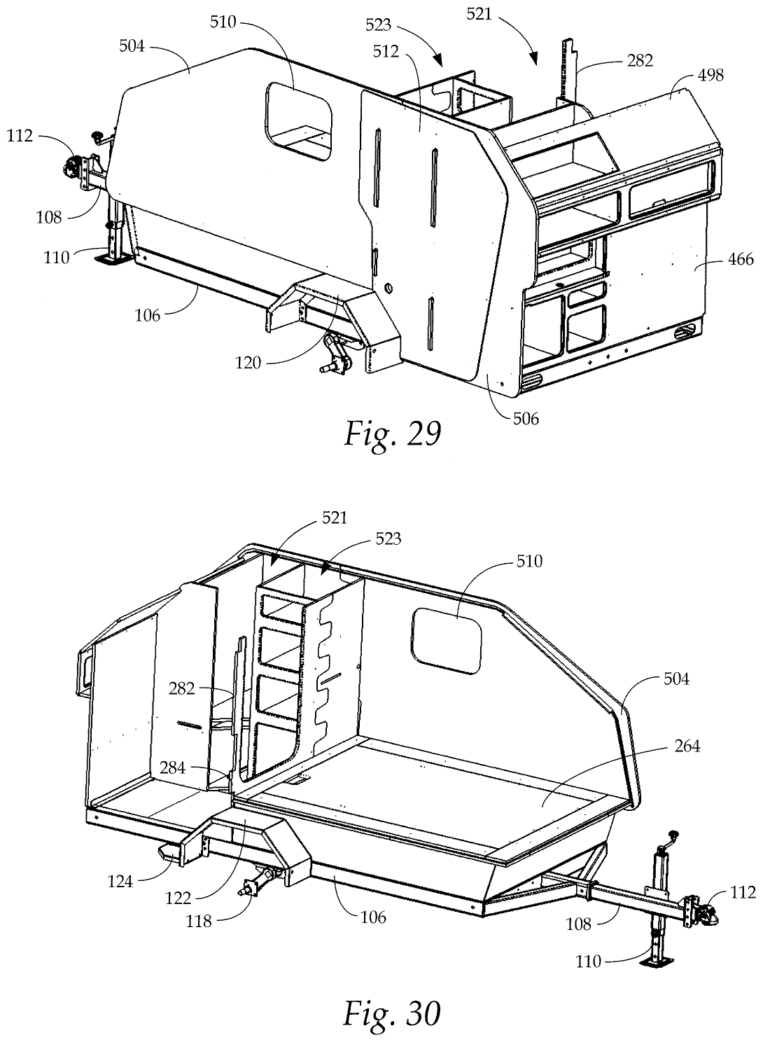

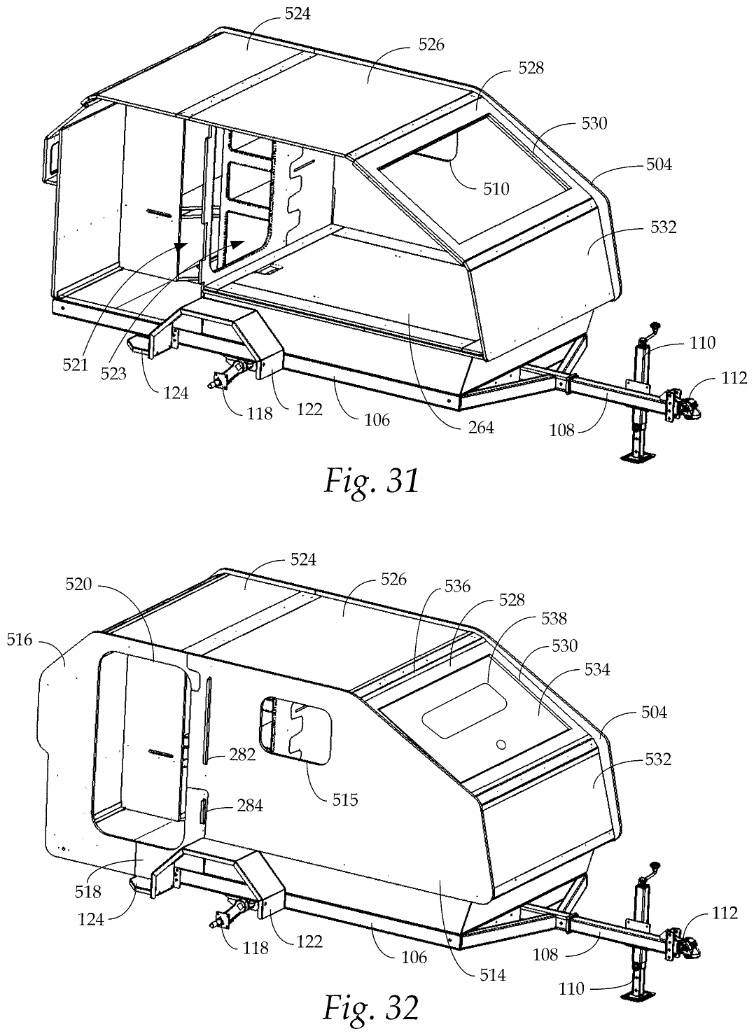

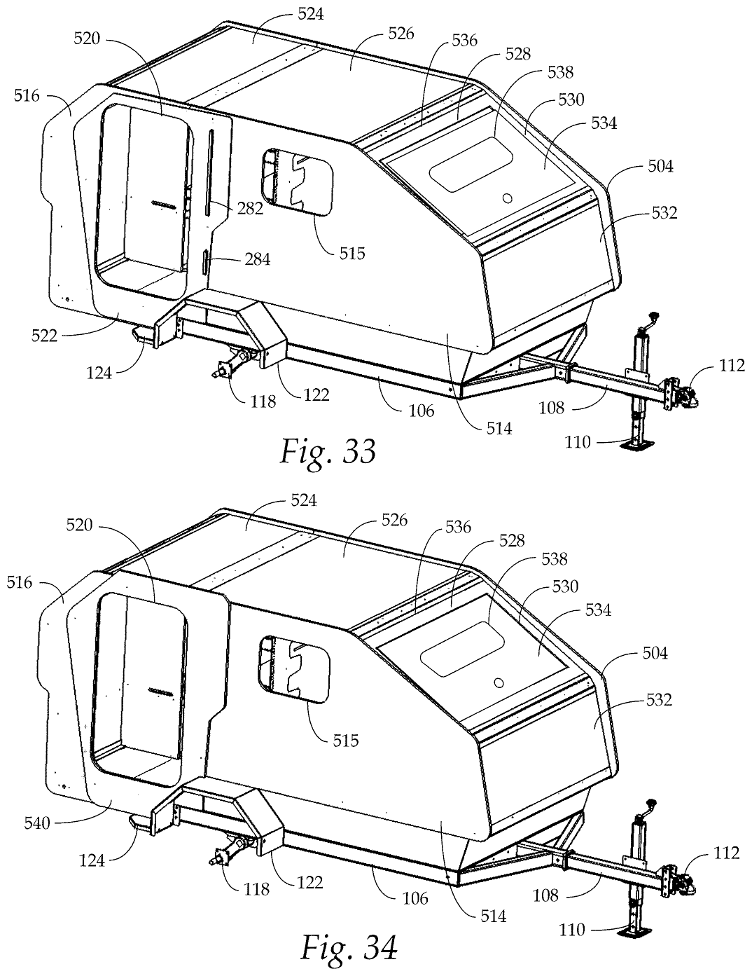

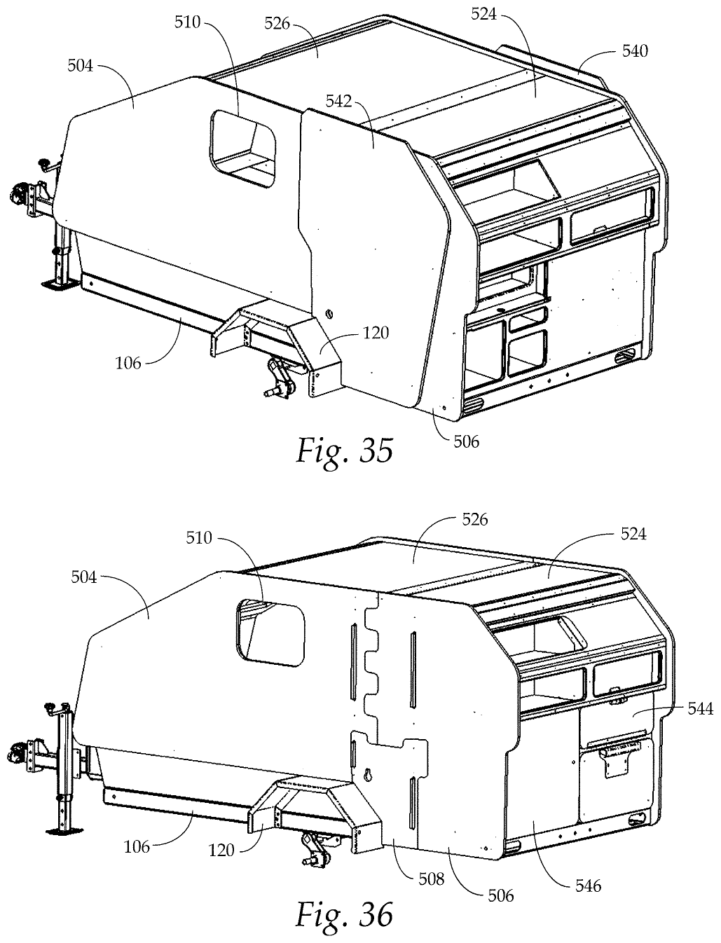

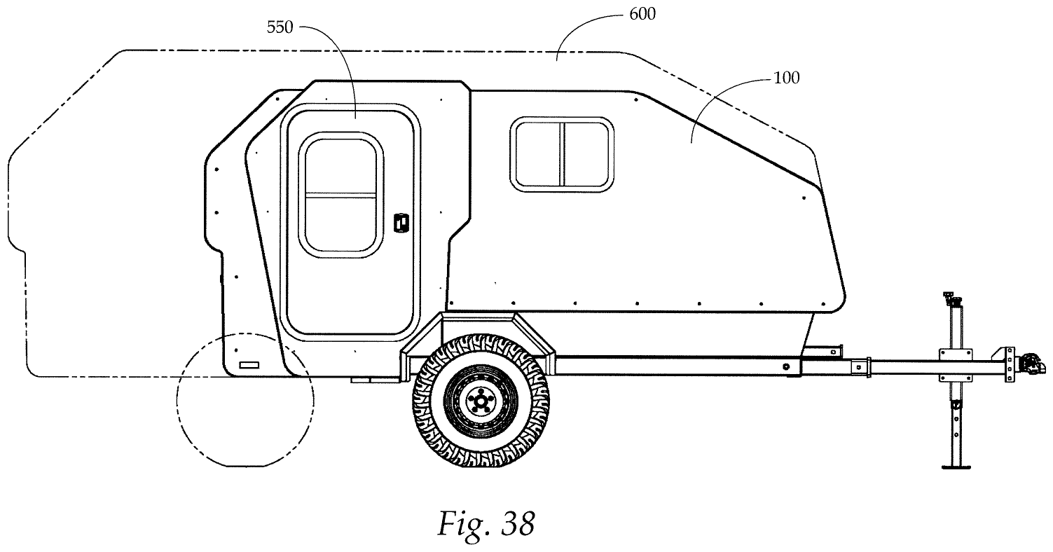

### DETAILED DESCRIPTION

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “forwardly,” “rearwardly,” “upwardly,” “downwardly,” “upper,” or “lower,” for example, all refer to a position or relationship of the item to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the recreational trailer as shown in the figures herein.

Referring to the figures, a monocoque recreational trailer of the present invention is generally indicated by reference numeral 100. The recreational trailer 100 includes a body 102 mounted on a chassis 104. The chassis 104 may include a frame 106, a tongue 108, a tongue jack 110, a hitch 112, wheels 114 and 116 with all terrain tires, coupled to an axle 118, and fenders 120 and 122 with a step 124. The tongue 108 may be fixed, removable, extendable, or adjustable. The hitch 112 may include a quick release coupler. The chassis 104 may be constructed of steel or aluminum, or any suitable material. The chassis 104 may be painted or powder coated for protection and durability and constructed of 7-gauge steel or other suitable material. The axle 118 may be a torsion axle with an independent suspension to provide stability to the recreational trailer. The fenders 120 and 122 may be structural for ease of access to the roof and be constructed of 7-gauge to 11-gauge powder coated steel or other suitable material with an integrated step 124. The fenders 120 and 122 may be structurally sufficient to support the weight of an adult.

A base platform 130 of the body 102 is provided and mounted to the frame 106 of the chassis 104. The base platform 130 includes three longitudinal ribs 132, 134 and 136, which may provide a support structure for a bed. Preferably the base platform 130 is sized to accommodate a 60″×80″ queen sized mattress. The outer two longitudinal ribs 132 and 136 include cutouts 138, 140, 142 and 144, which provide access to storage areas 145 on the outsides of the longitudinal ribs 132 and 134, and reduce the weight of the longitudinal ribs 132 and 134. Lateral panels 146, 148, 150, 152, 154, and 156 each include a tab 158, 160, 162, 164, 166, and 168, which are received in slots 170, 172, 174, 176, 178 and 180 in longitudinal ribs 132 and 134, respectively. The tabs 158, 160, 162, 164, 166, and 168 may be glued and/or mechanically fastened within the respective slots 170, 172, 174, 176, 178 and 180. A generally U-shaped center panel 182 includes a slot 184, which is received in a reciprocal slot 186 in the center longitudinal rib 134. The U-shaped center panel 182 is glued and/or mechanically fastened within the slot 186. A center lateral crossmember 188 is seated in notches 190, 192 and 194 in longitudinal ribs 132, 134 and 136, respectively. Upper left tab (not shown) and right tab 196 are received in corresponding slots 198 and 200 in center lateral crossmember 188. The upper left tab (not shown) and right tab 196 may be glued and/or mechanically fastened within the respective slots 198 and 200.

The base platform 130 includes sub-periphery 202. The sub-periphery 202 includes outer longitudinal panels 204, 206, 208 and 210. Upper tabs 212, 214, 216 and 218 of outer longitudinal ribs 132 and 136 are received in slots 220, 222, 224 and 226, respectively, or outer longitudinal panels 204, 206, 208 and 210, respectively. The upper tabs 212, 214, 216 and 218 of outer longitudinal ribs 132 and 136 may be glued and/or mechanically fastened within slots 220, 222, 224 and 226, respectively. Outer longitudinal panels 204, 206, 208 and 210 may be glued and/or mechanically fastened along the upper edges 228 and 230 of outer longitudinal ribs 132 and 136, and upper edges 147, 149, 151, 153, 155 and 157 of lateral panels 146, 148, 150, 152, 154 and 156, respectively. Lateral front crossmember 232 and lateral rear crossmember 234 include notches 236, 238, 240 and 242 at each end, respectively, which engage tabs 244, 246, 248 and 250 in outer longitudinal panels 204, 208, 206 and 210, respectively. The tabs 244, 246, 248 and 250 are glued and/or mechanically fastened within the respective notches 236, 238, 240 and 242. An upper center lateral crossmember 252 is glued and/or mechanically fastened to center lateral crossmember 188. A bed base 254 includes a periphery with front 256 and rear 258 lateral panels and left 260 and right 262 longitudinal panels. A base panel 264 includes a handle notch 266 and is hingedly attached along a rear edge 268 to the front edge 270 of rear lateral panel 258. Panels 256, 258, 260 and 262 are glued and/or mechanically fastened to the respective underlying panels to form a sturdy and rigid base platform 130. The base platform 130 is mounted to the frame 106 of the chassis 104. A subfloor 272 is mounted to the frame 106 of the chassis 104 to the rear of the base platform 130. The base panel 264 may be raised to gain access to a storage area 247 under the bed.

An interior wall 274 with an opening 276 to the bed base 254 is glued and/or mechanically fastened to the end of the bed base 254 partially enclosing a storage area 278 and enclosing a storage area 280 under the base panel 264. The interior wall 274 includes tabs 282 and 284 on an outer portion 286 of the interior wall 274, and keys 288 and locks 290 on an inner portion 292 of the interior wall 274.

A first cabinet wall 294 is glued and/or mechanically fastened to the end of the bed base 254 enclosing the storage area 278. The first cabinet wall 294 includes tabs 296 and 298 on an outer portion 300 of the first cabinet wall 294, and keys 302 and locks 304 on an interior portion 306 of the first cabinet wall 294. The keys 302 and locks 304 of the first cabinet wall 294 are aligned with and interconnect with corresponding locks 290 and keys 288, respectively, of the interior wall 274 to form a ridged and structural wall 308. The keys 302 and locks 304 of the first cabinet wall 294 and corresponding locks 290 and keys 288, respectively, of the interior wall 274 may be glued or otherwise fastened together along the joint formed between the first cabinet wall 294 and the interior wall 274. Transverse shelf grooves 310, 312 and 314 may be formed in a rear-oriented surface 316 of the first cabinet wall 294 and interior wall 274. A vertical cabinet face groove 318 may be formed in the inner portion 292 of the interior wall 274 intersecting with the transverse shelf slots 310, 312 and 314.

A cabinet face 320 includes grooves 322, 324 and 326, which are coplanar with slots 310, 312 and 314, respectively. Shelves 328, 330 and 332 are received in grooves 310 and 322, 312 and 324, and 314 and 326, respectively, and are glued and/or mechanically fastened in place, and which support the shelves 328, 330, and 332 along two sides. The shelves 328, 330 and 332 include tabs 334, 336 and 338. Openings 340, 342 and 344 in cabinet face 320 provide access to storage spaces 346, 348 and 350 above the shelves 328, 330 and 332, respectively. A forward-facing vertical edge 352 of cabinet face 320 is received in the vertical cabinet face groove 318 and is glued and/or mechanically fastened in place. A rear-facing vertical edge 354 of cabinet face 320 includes a plurality of pins 356.

A second cabinet wall 358 includes tabs 360 and 362 on an outer portion 364 of the second cabinet wall 358. Horizontal slots 366, 368 and 370 in the surface 372 of second cabinet wall 358, may be positioned and sized to receive tabs 334, 336 and 338, respectively, of shelves 328, 330 and 332, respectively. Tabs 334, 336 and 338 may be glued and/or mechanically fastened with slots 366, 368 and 370, respectively. A plurality of tails 374 in vertical edge 376 or second cabinet wall 358 are arranged to receive the plurality of pins 356 of rear-facing vertical edge 354 of cabinet face 320. The pins 356 and tails 374 are glued and/or mechanically fastened together.

A base panel 376 may be glued and/or mechanically fastened to the subfloor 272. Base panel 376 may include slots 378, 380, 382, 384 and 386, and notch 388. Panels 390 and 392 include tabs (not shown), which are received in slots 378, 380, 382, 384 and 386 and glued and/or mechanically fastened in place securing panels 390 and 392 to the base panel 376. Panel 394 includes a tab (not show), which is received in notch 388 and glued and/or mechanically fastened in place to secure panel 394 to the base panel 376 and secure to panel 390. A horizonal shelf 396 may be placed between and secured to panels 390, 392 and 394. A horizontal panel 398 may include a forward tab (not shown), received in a horizontal slot 400 in the surface 372 of second cabinet wall 358. Horizontal panel 398 may include slots 402, 404, and 406 to receive upper tabs 408, 410 and 412 of panel 390. Horizontal panel 398 may include slots 414 and 416 to receive upper tabs 418 and 420 or panel 392. Horizontal panel 398 may include notch 422 to receive tab 424 of panel 394. Horizontal panel 398 may include slots 426, 428 and 430 to receive tabs (not shown) of spacer panel 432.

Spacer panel 432 is received in a slot 434 of horizontal panel 436 positioned above horizontal panel 398. Horizontal panel 436 includes slots 438, 440 and 442 for receiving tabs (not shown) along a lower edge of panel 444. An inside edge 446 of panel 444 is received in a slot 448 of inside vertical panel 450. A sliding panel 452 is received in a space 454 between horizontal panel 398 and 436, and includes mechanical slides (not shown) received in slots 456 and 458 of horizontal panel 398. An inside lateral panel 460 includes an inside edge 462 received in a slot 464 of inside vertical panel 450. A rear vertical subpanel 466 is secured to inside vertical panel 45 and includes ports 468 470, 472 and 474 to allow for access to storage areas 476, 478, 480, and 482 formed by the panels.

Horizontal shelf 484 is secured to panels 444, 450, and 466. Horizontal shelf 486 is secured to panels 444 and 450 above horizontal shelf 484. A rear panel 488 with openings 490 and 492 is secured to horizontal shelves 484 and 486 and panel 450 to form storage spaces 494 and 496. A sloped upper panel 498 is secured to rear panel 488 and includes an opening 500 to provide access to storage space 502.

Exterior right-side panels 504, 506 and 508 include keys and locks, which together form a single, integrated, ridged and structural side panel. The exterior right-side panel 504 includes a window opening 510 and a dual vent window with a removable screen 511. The exterior right-side panels 504, 506 and 508 receive tabs 296, 298, 360 and 362 to structurally tie the exterior right-side panels 504, 506 and 508 to the interior panels to form a rigid, structural box. The exterior right-side panels 504, 506 and 508 are glued and/or mechanically fastened to the interior panels. An exterior right-side cover panel 512 is fastened over the seams formed between exterior right-side panels 504, 506 and 508 to seal the seams. One or more closets 521 are presented along with storage compartments 523. A flip-down seat 555 may be included in the interior of the recreational trailer to provide additional seating.

Exterior left-side panels 514, 516 and 518 include keys and locks, which together form a single, integrated rigid and structural side panel. The exterior left-side panel 516 includes a door opening 520. The exterior left-side panels 514 and 518 receive tabs 282 and 284 of interior wall 274 to structurally tie the exterior left-side panels 514, 516 and 518 to the interior panels to form a rigid, structural box. The exterior left-side panels 514, 516 and 518 are glued and/or mechanically fastened to the interior panels. An exterior left-side cover panel 522 is fastened over the seams formed between the exterior left-side panels 514, 516 and 518 to seal the seams. Exterior left-side panel 514 includes a window opening 515 to receive a window 517.

Roof panels 524 and 526 are fastened between exterior right-side panels 504 and 506 and exterior left-side panels 514 and 516. A front sloping panel 528 with an opening 530 is fastened between exterior right-side panel 504 and exterior left-side panel 514. A front panel 532 is fastened between exterior right-side panel 504 and exterior left-side panel 514. A cargo hatch 534 is hingedly secured to front sloping panel 528 along hinge line 536. The cargo hatch 534 includes a dual vent window with a removable screen 538. A left structural panel 540 is secured over exterior left-side cover panel 522 to further strengthen the integrated left side panel. A right structural panel 542 is secured over exterior right-side cover panel 512 to further strengthen the integrated right-side panel.

A fold-down counter 544 may be hingedly secured to the rear vertical subpanel 466. A door 546 may be hingedly secured to the rear vertical subpanel 466. A raisable cover 548 may be hingedly secured to roof panel 524. A door 550 may be secured to left structural panel 540 over door opening 520.

The exterior panels may be made of a layered structural panel 552. The layered structural panel 552 may include a metal skin 554, such as steel or aluminum, for example, an open cell extruded material 556 such as air-bubble extruded polypropylene, with a core 558 of an insulating material such as EPS foam. The metal skin 554 may be coated with an enamel paint, powder coated, or coated with a polyvinylidene fluoride coating, for example.

The recreational trailer 100 may be readily proportionally sized to form a longer and/or taller and shorter and/or smaller recreational trailer 600. The recreational trailer 600 may have a wheel assembly 602 that is rearward from the wheel 116 placement on the recreational trailer 100 to provide support and stability to the recreational trailer 600. The interlocking panels of the present invention form a monocoque structure that may be of any suitable size. The monocoque structure reduces the weight of the body, reduces the panel count, eliminates separate framing members, and in turn reduces the cost of materials and labor to construct. By reducing the weight of the body, the chassis may be constructed of higher quality and stronger materials.

While certain forms and embodiments of the vehicle carton and method for forming the same have been illustrated and described herein, the present invention is not to be limited to the specific forms or arrangement of parts described and shown, and that the various features described may be combined in ways other than those specifically described without departing from the scope of the present invention.

1. A recreational trailer comprising:
a body having exterior panels comprising a floor and interior components, sides, a front, a back and a roof;
said exterior panels integrated together with said interior components to form a rigid structure.

2. The recreational trailer of claim 1 further comprising a chassis, said floor of said body coupled to said chassis.

3. The recreational trailer of claim 2 further including said chassis includes an axle and tongue coupled to said chassis and two wheels coupled to said axle.

4. The recreational trailer of claim 3 wherein said tongue is extendable.

5. The recreational trailer of claim 1 wherein said interior components include a bed base coupled to said floor, sides and front of said exterior panels.

6. The recreational trailer of claim 1 wherein said interior components include storage compartments coupled to said floor, a side and roof of said exterior panels.

7. The recreational trailer of claim 1 wherein said interior components include a closet coupled to said floor, a side and roof of said exterior panels.

8. The recreational trailer of claim 1 wherein said front exterior panels include a cargo hatch providing access to a bed area.

9. The recreational trailer of claim 1 wherein said back exterior panel includes interior storage bins fastened to said interior components.

10. The recreational trailer of claim 1 wherein said interior components include a bed, a closet and storage shelves.

11. A recreational trailer comprising:
a body having exterior panels comprising a floor, and interior components, sides, a front, a back and a roof;
said exterior panels integrated together with said interior components to form a rigid structure;
a chassis;
said body fastened to said chassis wherein said exterior panels and interior components are fastened together to form a monocoque structure.

12. The recreational trailer of claim 11 wherein said chassis includes an axle and tongue coupled to said chassis and two wheels coupled to said axle.

13. The recreational trailer of claim 12 wherein said tongue is extendable.

14. The recreational trailer of claim 11 wherein said interior components include a bed base coupled to said floor, sides and front of said exterior panels.

15. The recreational trailer of claim 11 wherein said interior components include storage compartments coupled to said floor, a side and roof of said exterior panels.

16. The recreational trailer of claim 11 wherein said interior components include a closet coupled to said floor, a side and roof of said exterior panels.

17. The recreational trailer of claim 11 wherein said first exterior panels include a cargo hatch providing access to a bed area.

18. The recreational trailer of claim 11 wherein said back exterior panel includes interior storage bins fastened to said interior components.

19. The recreational trailer of claim 11 wherein said interior components include a bed, a closet and storage shelves.

20. The recreational trailer of claim 11 wherein said interior components include a flip-down seat.

21. A recreational trailer comprising:
a body having exterior panels comprising a floor, and interior components, sides, a front, a back and a roof;
said exterior panels integrated together with said interior components to form a rigid structure;
a chassis having a frame, an axle and tongue fastened to said frame and two wheels coupled to said axle;
said body fastened to said chassis wherein said exterior panels and interior components are fastened together to form a monocoque structure.

22. The recreational trailer of claim 21 wherein said tongue is extendable.

23. The recreational trailer of claim 21 wherein said interior components include a bed base coupled to said floor, sides and front of said exterior panels.

24. The recreational trailer of claim 21 wherein said interior components include storage compartments coupled to said floor, a side and roof of said exterior panels.

25. The recreational trailer of claim 21 wherein said interior components include a closet coupled to said floor, a side and roof of said exterior panels.

26. The recreational trailer of claim 21 wherein said first exterior panels include a cargo hatch providing access to a bed area.

27. The recreational trailer of claim 21 wherein said back exterior panel includes interior storage bins fastened to said interior components.

28. The recreational trailer of claim 21 wherein said interior components include a bed, a closet and storage shelves.

29. The recreational trailer of claim 21 wherein said interior components include a flip-down seat.
